(19) United States
(12) Patent Application Publication
(10) Pub. No.: US 2024/0212023 A1
(43) Pub. Date: Jun. 27, 2024

(54) UNIVERSAL PURCHASING SYSTEM AND METHOD

(71) Applicant: Edward F. Pender, St. Louis, MO (US)

(72) Inventor: Edward F. Pender, St. Louis, MO (US)

(21) Appl. No.: 18/391,065

(22) Filed: Dec. 20, 2023

Related U.S. Application Data
(60) Provisional application No. 63/434,675, filed on Dec. 22, 2022.

(51) Int. Cl. G06Q 30/0601; H04L 67/306

(52) U.S. Cl. CPC G06Q 30/0633; H04L 67/306

(57) ABSTRACT

Systems and methods for allowing a user in their home to provide a list of goods to be purchased. The goods are commonly identified by an in-home device and may include goods to buy which are typically specific items that are to be purchased, as well as shopping requests which are more open queries for goods where the specific good to be purchased may not known yet. The list is then broken down by the system into groups or sub-lists of goods where goods to be purchased can be automatically grouped into groups can be provided by a single online retailer meeting various preferences of the user. Once the groups have been created, each group portion of the list is then ordered from the single retailer using stored information on the purchaser's device to allow for purchases from multiple locations to occur at a single time and with only stored payment information that does not need to be reentered repeatedly.

### CROSS-REFERENCE TO RELATED APPLICATIONS

This application claims the benefit of U.S. Provisional Patent Application No. 63/434,675, filed on Dec. 22, 2022, the entire disclosure of which is herein incorporated by reference.

### BACKGROUND

### 1. Field of the Invention

This disclosure relates to the field of purchasing systems and particularly to universal purchasing systems which can order from multiple vendors from a singular list of goods.

### 2. Description of the Related Art

Shopping is an experience. While shopping necessarily involves buying products, the two are actually different things. As a simple example, most people go to the grocery store because they need to buy something. This is often a basic staple such as bread or milk. However, unless they are really in a hurry, many grocery shoppers do not simply go straight to the items they need to buy and then straight back to the checkout and out the store. Instead, a shopping trip often involves them going up and down aisles slowly accumulating what they need to buy while simultaneously looking for other items that may be of interest. These may be items that they happen to find interesting, where a discounted price may catch their eye, or because they meet a more open ended desire for an item. Often it is because they need a general item, for example a piece of meat for dinner, but the specifics of the item they desire only become known to them once they see many options.

For many a shopping trip is an enjoyable experience. The act of searching (even if they don't find anything they want) can itself be both interesting, relaxing and therapeutic. In effect, there are always two pieces to any shopping trip, the joy of shopping and looking at items for sale, and the act of buying items. It is important to recognize that the act of shopping typically results in buying, and the need to buy often spurs shopping, but while the terms are used interchangeably, they are not the same. A good example is traditional gift shopping. In gift shopping an individual will often have a basic idea of what they want (e.g. who it's for and what they might like) but they often don't have a specific set thing in mind to buy the person, Instead, they go somewhere that is likely to have things they expect the person to like, and then see what they find that they wish to purchase.

In traditional retail, the difference between shopping and buying could present a problem. If a person is looking only to buy, they are often in a hurry and want the process to be over quickly. Some stores cater to buying. A good example is convenience stores that often only carry limited items and don't really intend users to browse, but simply to purchase what they come in for. Because of the nature of most retail shores which cater to shopping and not buying, a buyer with a long list of items is often forced to travel to multiple different stores to obtain items from their preferred vendors, which could dramatically increase the amount of time that the trip takes and may force them to buy products from a particular retailer, or to skip buying certain products, due to time constraints. Alternatively, they may have to select less desirable, but similar, items to complete their buying in fewer stores and many displays in stores designed to appeal to shoppers who are browsing will be superfluous and in the way. A shopper, however, will often want a wide selection of product to review and browse and is not bothered having to move from location to location. However, even for a shopper, physical proximity of different stores can be desirable to make the shopping experience more about the shopping and less about the travel.

In traditional retail, the desire of both buyers and shoppers to have many goods collocated in a single space has long been recognized and traditional retail dealt with it by clustering multiple goods and then stores together to avoid the need to travel to purchase lists of goods. In the earliest examples of clustering, this was the creation of the department store, general retailer, or supermarket. These stores effectively clustered items that previously were provided in separate stores, in a common store. A great example is the supermarket which combined multiple food retailers within a single store. A supermarket combined a bakery, green grocer, and butcher shop (among others) which had previously all been separate into the same store as different “departments”. In effect, what may have been stores close together, but still spaced and requiring one to go outside to access them all, were brought under one roof. This provided the ability of the buyer to obtain multiple items at a single location, in a single trip, and with a single checkout, while also allowing the shopper to browse through multiple generally complimentary items. Thus, a buyer who needed eggs, bacon, and bread for a recipe that was partially completed at home could get all those items at the same place quickly, while a shopper, simply looking for a desirable meal, could also obtain the same items when they settled on what to make. Clustering proved an effective model and the growth of larger, more general, retail stores continued. However, as the selection of goods available to the consumer continued to increase, larger stores reached the point where they couldn't necessarily provide everything within their categories for both space and cost reasons.

Limited shelf space and the cost of real estate means that most larger stores have to focus on selling items that sell quickly and consistently and cannot carry many specialty items that may sell slower, even if they sell at a greater profit margin. For example, most supermarkets struggle to carry a wide selection of products catering to the needs of every taste of every culture. For example, a US supermarket will commonly sell a wide selection of chicken, pork, and beef, but will often not supply specialty meats such as goat, rabbit, or lamb to nearly the same degree (if at all). Similarly, seafood departments in supermarkets will typically carry common popular fish and shellfish (such as salmon and shrimp), but often not uncommon varieties (such as smelt or razor clams). These gaps are often still filled by specialty retailers where lower product turnover, but higher profit margins and reduced cost in the form of reduced overhead, can make carrying such items practical.

Traditional retail, however, learned again and not only began combining items from different stores into a single store, but placing different stores near each other. A shopping center, for example, will often include one or more large stores that offer a variety of goods, within walking distance (and commonly sharing a parking lot) with a number of smaller stores (and even large specialized stores) that can help fill the gaps. While store selection in a shopping center is not necessarily predesigned to fill specific shopping needs (although sometimes it is), stores will commonly join in a shopping center that they feel is a complementary fit to what they offer where the presence of the large “anchor” store will draw in customers who will then do additional shopping (or buying) at the other retailers. Support stores (such as restaurants) then also join the shopping center to further a shopping experience. Product selections within the various stores can also alter based on the stores being in the same shopping center. For example, it is not surprising to find a large supermarket in the same shopping center as a specialty bakery. The large shopping center supplies more general baked goods (with few specialty items) while the specialty bakery supplies few general baked goods, but an increased selection of specialty items.

The concept of placing stores nearby to simplify a shopping trip was taken one step further when the shopping mall served to place many complementary, and sometimes even directly competitive, stores under the same roof. In many respects, this made the mall one particularly large retail “store” (shopping environment) with the various stores therein acting as “departments” of the shopping mall in the same way as the “departments” of a supermarket. Malls also continued to get bigger allowing individual stores to sell even greater depth and the presence of more space allowing a wider diversity of stores, and increasingly specialized stores, to be present at the same location. However, bigger malls also started to have similar problems of physical locations becoming spaced out. While the retailers were under a common roof, the distance between stores at the opposing ends of a mall could make it hard to move between them in a single trip. Thus, shopping centers and shopping malls tended to earn their names as shopping, and not buying, destinations.

The Internet, in many respects, can be considered the world's largest shopping mall where virtually every store is available, and the full product lines of virtually any brand can be obtained. It has been estimated that in 2022 over 900 billion dollars will be spent in e-commerce in the United States alone and that number is only expected to increase as more people continue to become comfortable with the technology and Internet access continues to expand. The recent COVID pandemic also served to accelerate the growth of online sales as stay-at-home orders forced many to order items delivered to their home that they would have previously gone to a physical store to obtain, and many people have now acquired a preference for such ordering.

While the e-commerce marketplace is massive and lacks the real estate limitations of traditional retail with every product available from the comfort of your keyboard, much like traditional retail it is also a bit fragmented due to the need to fulfill product orders (even if there is no need to allow shoppers to touch or select product individually). Much like more traditional retail, e-commerce includes a large number of stores that specialize in particular products and other stores that provide more general and wider product selections. In many respects, this is a logical result as no one store (either traditional or online) can, or should, sell everything. Further, it means that e-commerce effectively tracks more traditional retail with large e-commerce sites such as Amazon.com or Wal-Mart.com selling a wide variety of more basic products in the same way that a traditional department store, supermarket, or general retailer sold product, while smaller e-commerce sites (and even manufacturer run sites) will often sell a greater depth of specialty goods, without selling as wide a variety of product, mirroring the selections of more specialized and typically smaller retail stores and factory outlets.

A major change of the Internet in retail has been the elimination of retail real estate. Online retailers don't need to have accessible stores with aisles and displays where shoppers need to go to look for and select goods to buy. Instead, the physical searching component of retail shopping has been replaced with a virtual storefront and electronic search tools. Now when someone wants to locate a particular good, instead of going to a store based on what the store “should” have and determine if they carry it, the user simply searches online retailers for the good. This can be both through a particular retail outlet's search engine (such as on Amazon.com) or generally in the Internet as a whole. If the search engine finds the good which is being sought, the shopper can then go to the linked site and obtain it. Instead of the user selecting the good and going through a physical checkout procedure to take the good with them from the retail store, the checkout is processed electronically and the good is then shipped from a distribution center or warehouse.

The elimination of the need to have retail real estate has dramatically altered what an online retailer needs for space. Distribution centers are more concerned with product density and accessibility to warehouse workers or robots than end shoppers. Further, distribution centers are more commonly positioned near transportation hubs as opposed to near population centers expected to be for the target audience. This has, in turn, allowed for the modern distribution center to house more goods in less, typically less expensive, space than a traditional retail store. Because of this, today's largest online retailers dwarf even the largest retail stores for goods selection.

With the ability to carry more goods, large online retailers carry many more types of goods together and a number of sites even act as consolidators for multiple retailers. Amazon, for example, sells many more types of products (and selections within those types) than even the largest physical stores. Further online retailers such as eBay sell far more used or secondary market goods than the largest flea market or garage sale and Etsy sells more handmade or specialty products than the largest craft fair could hope to. These online retailers still show a specific focus in the types of goods they sell, however. As indicated above, while there is cross over, sites such as Amazon tend to specialize mostly in mass market retail goods while eBay tends to sell secondary market goods, and Etsy focuses on handmade or unique items.

This specialization is in no way necessary for a distribution or order fulfillment reasons. Any of the above retailers can (and in some respects do) carry goods that overlap with the others. The reason it is common is to deal with how goods are often sold and how they are searched. Basically, it returns to the shopping versus buying issue. For example, many goods on Etsy are handmade to order and the site caters well to those shopping. Such goods are typically not warehoused because they can't be and fulfillment of an order is not distribution of identical product from the closest storage facility in direct response to an order. In these types of goods, the shipping is typically handled by the manufacturer directly. Further, because different individuals may offer similar, but distinguishable goods, the manufacturer often handles the sale because they can best market their unique differences to different buyers.

However, e-commerce sites have all gained by having items under one digital “roof”. Specifically, am online vendor may not be selling the product at all. On some sites such as Etsy and eBay, the site really is just a front end and link to an underlying manufacturer or vendor's electronic marketplace with the larger online marketplace simply handling search and payment on the transaction with all other activity handled by an underlying retailer. In this way, some of these sites provide much of the infrastructure to another vendor, for a fee, while the other vendor can still have some control over fulfilment and marketing which they basically handle on their own.

Even with the biggest online retailers, it is very hard to get all the products even a single household uses and most people, on a regular basis, need to purchase from multiple vendors to find all the products they wish to consume. In effect, the online experience has morphed into a strange hybrid of shopping and buying. In many respects, large e-commerce sites are generally built solely around buying. While the systems may provide for some browsing of items (e.g. by providing a selection of related items in response to a search) the system are effectively built around search engines whose goal is to locate a specific target product the person wants to buy as quickly as possible, and then simplify the process of buying it. However, the necessary design of a search engine hampers a pure buying experience because a user has to search for every product which can slow down the buying process.

In this way, the fragmentation of the Internet presents a dilemma for both the shopper and the buyer. While the e-commerce space has catered to buying quickly and easily, the sheer scope of e-commerce has made it dependent on search engines and query functionality which better mimic shopping. One cannot run quickly into an Internet retailer and find specifically what you need because you know where it is, and then check out quickly. Instead, one is often dependent on performing multiple searches and going through results. At the same time, the shopper is also hampered by search engines whose goal is to find a target good quickly and facilitate buying it. This can make browsing difficult and make it hard to go through a wide selection of different goods to find something that is desired to meet a specific, but not completely understood need.

Search functionality is not interesting to the shopper who is often unable to provide more open ended inquiries or to simply seek out a wide selection of general products to browse through. The dilemma is made even worse if a list of desired goods includes products from multiple categories (specific items to be bought and more general items to be shopped for) that are not carried by a single retailer. Thus, both the buyer and the shopper, in order to purchase a list of disparate items at the same general time (e.g. in the same morning), is often forced to make compromises in where or how they obtain the products they eventually obtain. Further, as many people on a single shopping trip have a list of both types of items (e.g. “bread”, “milk”, and “something for dinner”) online shopping is often a less than ideal experience.

While obtaining products online involves no physical travel like it used to, Internet commerce has created new problems in “distance.” This includes difficulty in checkout where information must be repeatedly entered at different sites and not knowing where best to obtain a list of items efficiently or for the best cost or features. As consumers move online in their shopping, they begin to order certain items from certain websites because they know which site has the item or may have price benefits, desired shipping or pickup options, or other features that they prefer. While shopping multiple online sites allows for access to an excellent selection of goods and a variety of purchasing options, it also dramatically complicates the online purchasing process by duplicating checkout procedures between retailers and requiring the user to keep track of information about online vendors. Vendors have often responded to this by having users sign up for accounts so their information is stored. However, this can result in the user being subjected to marketing communications and taxing the ability of search engines to return desired results unless the search engine is limited to the particular vendor, which then limits its scope.

Specifically, the consumer when placing an order from a single list of goods often now has to visit multiple sites, perform multiple searches, review a plethora of results, many of which are not what they are actually looking for, know what to get from each site (often having to meet minimum sale sizes to get desirable outcomes such as free shipping), navigate each site's specific online shopping cart and ordering process, enter payment information in virtually all cases (even when it is often identical across different retailers), and get a separate package from each retailer or go to multiple pickup locations to actually get the product. This process results not just in inefficiencies in the delivery portion of the ordering, but also in the ordering process itself.

To deal with these problems, products and services have sprung up to try and simplify various pieces of the shopping experience typically through consolidation. For example, massive single retailers (such as Amazon) try and centralize purchases by a single vendor offering wide variety as well as consolidated and inexpensive shipping. However, massive sites like these still can't offer everything and their systems often break down at search because the sheer size of their offerings makes it hard to navigate them with anything other than specific queries for specific goods. Further, because these single retailers can carry so many often similar goods it is often hard for the shopper to distinguish desired goods from similar looking, lower-cost, and often inferior competitors than can purposefully manipulate their appearance and search results precisely because the user is so dependent on the search to return relevant results. Additionally, services such as SquarePay and ApplePay have tried to simplify the payment process to allow for the provision of purchasing information to be shared across multiple vendors. However, these systems are only as good as the vendors that they consolidate and often still require independent log-ins at each vendor.

As a still further result, more general Internet search engines often focus more on buying and commercial behavior than result generation. This can be valuable if you are shopping, but can result in poor results for research or other purposes for which the Internet is often used. Further, while large general search engines can search multiple e-commerce sites and then suggest locations that may have the specific good, it presents a new issue. If the user is shopping for multiple goods at the same time, they now need to determine if the site selected for any one item also has any of the other items they are interested in. This essentially presents the original problem of who has what in inventory again.

In effect, the online retail process often breaks down at a couple of key points compared to traditional retail. Firstly, search engines are often too general and usually too linear in their presentation to handle a large number of disparate items quickly slowing the buyer. Basically, search items work well when looking for one specific item. When many different items are desired (as is often common on a shopping list), the linear nature of search means that a separate search is typically required for each item, which can be slow and tedious. Further, search is also dependent on being able to describe an item accurately. When someone is looking for a specific item that is hard to describe to a machine, the search engine is forced to supply a list often curated by others. For example, a search for “bread” can return large numbers of different manufacturer's and product sizes even though the user is actually searching for a particular type and size of bread. Thus, getting a search to return the target item can be inefficient.

The second key point of breakdown is at payment and fulfillment. In traditional retail, the checkout experience has been dramatically simplified and accelerated with hardware. Credit card scanners are far more secure, and quicker, than manual entry of credit card numbers. However, most shoppers don't have the hardware infrastructure in their home to handle this and online sales are typically clunky as they rely on human interface tools (such as keyboards) to obtain information that can be obtained directly from a purchase system (such as the microchip in a credit card or a transmitter in a smartphone) if hardware to read those items is available.

Further, in traditional retail, the user could leave with multiple bags and boxes from multiple stores which all ended up in their vehicle and travelled together. This resulted in minimal additional transportation costs and was simple. However, in the online retail space, due to the need to deliver or pickup goods, a user often has to go through more complicated and expensive process of having product shipped or pick it up. This can require entering shipping addresses (again, repeatedly at multiple locations), and also paying for shipping on top of the goods they wish to purchase. Thus, shipping from multiple retailers can dramatically increase cost and hassle of obtaining the goods.

In the same way that a shopping mall acts to assist both buyers and shoppers by providing a single location in which a consumer to purchase a long list of different goods, from different vendors, and with only a modicum of travel, it would be desirable for online consumers to be able to enter a list of goods that they are interested in obtaining into a single portal and have the system be able to assist in obtaining those goods from a variety of providers without the user needing to seek out how to do so. Essentially, to treat items to be bought differently from items to be shopped for while consolidating fulfillment of orders from both into a streamlined delivery process.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are systems and methods for allowing a user in their home, to provide a list of goods to be purchased. The goods are commonly identified by an in-home device and may include goods to buy which are typically specific items that are to be purchased, as well as shopping requests which are more open queries for goods where the specific good to be purchased may not known yet. The list is then broken down by the system into groups or sub-lists of goods where goods to be purchased can be automatically grouped into groups can be provided by a single online retailer meeting various preferences of the user. This can serve to take much of the clunkiness and linearity of search away from goods to be bought as well as simplifying the fulfillment of the purchase by reducing retailers and providing the goods in a preferred fashion. At the same time, the system can also provide for a shopping experience where the user is provided with many different goods from multiple retailers as part of a curated grouping. This can allow the user to select from the grouping the specific good that they want. This selected good can then be automatically combined with the bought goods to further minimize any hassle in purchasing and fulfillment. Once the groups have been created, each group portion of the list is then ordered from the single retailer using stored information on the purchaser's device to allow for purchases from multiple locations to occur at a single time and with only stored payment information that does not need to be reentered repeatedly.

There is described herein, among other things, a method, and a computer system using the method, for consolidated ordering, the method comprising: providing a software portal for accepting a consolidated list of items from a user; breaking the consolidated list of items into a plurality of sub-lists, all items on each sub-list in the priority of sub-lists are available from a single vendor; determining preferences of the user with regards to ordering; modifying the plurality of sub-lists into a plurality of modified sub-lists wherein: the plurality of modified sub-lists are different from the plurality of sub-lists; and all items on each modified sub-list are available from a single vendor; retrieving stored ordering information of the user; and automatically providing at least a portion of the stored ordering information to a vendor for each modified sub-list so that the vendor is given an order for the items on each modified sub-list and will supply the items on the modified sub-list to the user.

In an embodiment of the method, the software portal is a software application for use on a mobile device.

In an embodiment of the method, a plurality of the items are available from multiple vendors.

In an embodiment of the method, the stored ordering information includes payment information.

In an embodiment of the method, the stored ordering information includes shipping information.

In an embodiment of the method, the stored ordering information includes delivery information.

In an embodiment of the method, the items include a mass market item available from multiple vendors.

In an embodiment of the method, the items includes a unique item only available from a single vendor.

In an embodiment, the method further comprises: showing the user an item based on an indicated item on the list that may or may not be the item on the list and the user will indicate if they wish the shown item to be placed on a sub-list as the indicated item or not.

In an embodiment, the method further comprises: showing the user another item that may or may not be the indicated item on the list when the user indicates not to place the shown item on the sub-list and the user will indicate if they wish the another shown item to be placed on a sub-list or not.

In an embodiment of the method, the order is supplied using an existing e-commerce portal of the vendor.

In an embodiment of the method, the order is supplied in a non-electronic form.

### BRIEF DESCRIPTION OF THE DRAWINGS

FIG. 1 Provides a portion of a flowchart showing an embodiment of a method that may be implemented by a system of the present disclosure in conjunction with the creation of an original list of goods and the use of the lost to locate goods to be bought or reviewed.

FIG. 2 Provides a portion of a flowchart showing an embodiment of a method that may be implemented by a system of the present disclosure in conjunction with group creation and fulfillment of orders

FIG. 3 Provides a portion of a flowchart showing an embodiment of a method that may be implemented by a system of the present disclosure in conjunction with the registration of vendors and creation of the database of goods to be provided which is used to potentially fulfill the user's requests.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matters contained in the description or shown in the accompanying drawings shall be interpreted as illustrative and not in a limiting sense.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wrist-wear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth™ and other wireless communication devices, virtual memory, storage devices and associated controllers, firmware, and device drivers. The systems and methods described herein are contemplated to use computers and computer software typically stored in a computer- or machine-readable storage medium or memory.

Throughout this disclosure, terms used herein to describe or reference media-holding software, including without limitation terms such as “media,” “storage media,” and “memory,” may include or exclude transitory media such as signals and carrier waves.

Throughout this disclosure, the term “network” generally refers to a voice, data, or other telecommunications network over which computers communicate with each other. The “Internet” is a well-known global network generally accessible by users. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

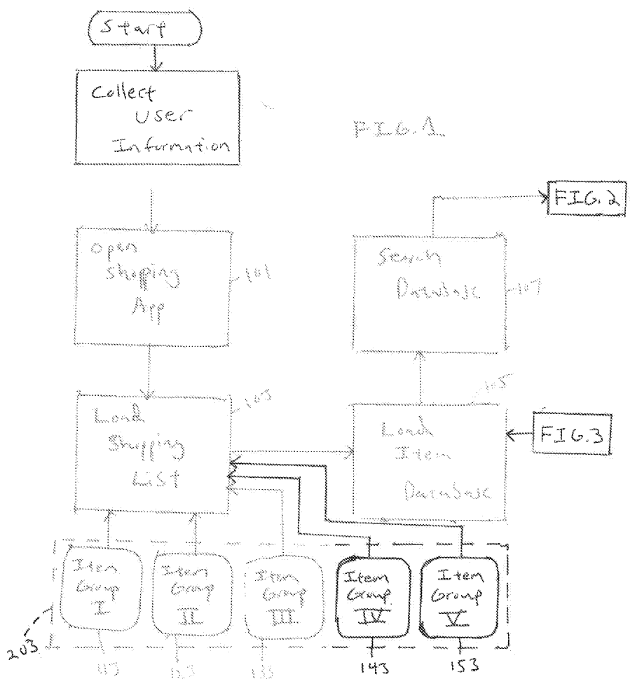

FIGS. 1-3 provide for a general flowchart of the method of operation of an embodiment of an online system for distributing orders across multiple retailers from a single list of goods to be purchased. The system typically uses automation to simplify a buying action and uses curated searching to provide for an improved shopping action based on the nature of the good. In a general sense, goods which are interchangeable and can be specifically described (often mass market retail goods) or where the user is looking to obtain them at the least price and/or in accordance with preferred shipping methods or vendors are provided as goods to be “bought”. In effect, the system treats handles to be bought with a simplified front end where much searching can be eliminated and a backend fulfillment that consolidates e-commerce with a single checkout, even when from multiple vendors. At the same time, goods which require more “shopping” to settle on, are treated differently at the front end by utilizing displays that facilitate browsing. Once goods are settled on, these are then treated to the same consolidated backend fulfillment. However, they often gain less from the consolidation of this step.

Typically, the system will begin operating in accordance with the described methods by the actions of a user choosing to interact with it. In step (101) a user will first open a single shopping application or other access portal on a computer under their control. This may be something such as a shopping webpage running on a computer acting as a client for an associated server via network, may be a software application (“app”) running on a mobile device such as a smartphone or tablet computer, or may be any other type of software or other application operating on any other type of computer device. For purposes of this exemplary embodiment, the discussion will presume that this is a software app running on a standard smartphone. Once the app is open, the user will enter (103) a shopping list of goods (203) into that portal. Entry of the list may be in any fashion and may use multiple methods together.

In order to clearly present an embodiment of the method of operation of the system, it is presumed that the list of goods (203) includes disparate goods all of which are not available from a single retailer. As illustrated in FIG. 1, this discussion assumes that in the list (203) there are five item groups: Groups I (113), II (123), III (133), IV (143) and V (153). It is important to an embodiment that the user of the system has not necessarily separated the item groups I (113), II (123), III (133), IV (143), and V (153) to the system and the user will typically not even actually recognize many of the divisions themselves. Instead, this division of the list (203) which exists at this stage of the flowchart of FIG. 1 only for illustration that the list (203) includes disparate types of goods. Practically, there is a single list (203) which is basically what is to be purchased in this online shopping trip.

The list (203) in the example of FIG. 1 is intended to represent a list of items from a typical shopping list, but the chosen examples used herein are selected to illustrate system operation and will not typically be on a single list. In particular, it is designed to represent a grocery list through items (113), (123), and (133) as well as two other items. List (143) is designed to be an opened ended item which is not specifically known and is called a “Selection Required Item” herein. For example, the list (143) may be something like “a gift for dad,” “a piece of art for the living room”, or “something to take to the potluck.” This list (143) is not for a specific item, but more a cue to the user that they need to select some item to fill that need, but don't necessarily know what they are yet. The final list (153) is for a specific item, but it is an item that will require additional determination to see if it is actually to be purchased and is called a “Hybrid Item” herein. In the grocery case, this may be a general term for a grocery item such as “bread”. “milk”, or “apples.” While these are specific things, they are too broad of statements to mean a particular item. For example, there are multiple kinds of apples and they are often obtainable in highly variable quantities. Thus, in a Hybrid Item, a search is clearly narrowed (e.g. a search for apples need not return the options of oranges), but there is still refinement necessary from the user.

While the above contemplates how this can work in groceries, Hybrid Items such as those on the list (153) are often most clearly illustrated when they are secondhand or collectable items where the good may be able to be identified very specifically, but even a matching good may not meet the criteria to actually be purchased. For example, the user may wish to obtain a very specific collectible item, such as particular baseball card which can be readily identified by player, manufacture, year and condition. However, even if the specific good is located, the user will typically be unwilling to buy it without inspecting actual imagery of the good. For example, a baseball card, even of an official collectors condition, can have different flaws and the user may wish to determine if those flaws are acceptable or not before purchase. Further items in this category may have widely disparate prices which may also effect the user's desire to complete the sale.

A key element of the list (203) is that all the items on all the lists (113), (123), (133), (143) and (153) can all be obtained online if they can be located and will be ordered using online e-commerce ordering by the user if they are presented with the item they decide they want. Further, while the above are exemplary items of different types, lists having some, all, none, other, or any combination of items can be obtained using the system. Further, the system will often show the clearest benefit the more disparate the items on the list (203) are.

To understand the operation of the system, the disclosure will begin by discussing the systems operation in conjunction with items to be “bought.” These are the first three groups (113), (123) and (133). These lists are for items which are, for all intents and purposes, interchangeable with each other. For example, a new box of cereal is typically functionally the same as another new box of the same cereal making them interchangeable. Thus, these lists (113), (123) and (133) all include items that the user wishes to buy. They know what the item is, can identify it, and want that specific thing. To put it another way, the item can be identified to the machine in a way that a single result is almost certainly the desired item. In this example, the first group (113) of list (203) comprises a series of specific fresh grocery items (e.g. a five pound bag of red potatoes) which are available for local delivery or pickup from a green grocer that is local to this user.

The second group (123) comprises a number of packaged food goods which are not sold at the green grocer, but are available for delivery by standard shipping methods from a large retailer's central warehouse. The second group (123) items are also available for pickup from a local branch of the same large retailer and the same large retailer also sells the grocery items of the first group (113), but those have to be picked up at the local branch and cannot be delivered as they are not available from the warehouse.

The third group of items (133) are specific specialty packaged food items which are not available to the user locally at all, and must be ordered from a specialty site catering in these types of food items and shipped. This specialty site can only deliver items via mail to this particular user due to geographic distance. The specialty site can also supply some of the packaged items of the second group (123) but at a much greater price than the large retailer and has some of the fresh grocery items of the first group (113) available in their inventory, but will not sell them to this user or any non-local purchaser as they cannot be shipped but must be picked up.

Entry (103) of the shopping list (203) can occur via a number of methods as would be understood by one of ordinary skill in the art. In an embodiment, the user would utilize the smartphone running the shopping app, and as part of the app, to scan in a machine readable codes such as, but not limited to UPC “bar codes” from the various products which would serve to identify them. For items that do not have UPC codes (such as certain fresh grocery items, for example although many fresh grocery items do now have scannable codes), selections of previously purchased items may be provided as may general lists of common items usually associated with items already selected. Alternatively, the user may have a record of previously purchased goods which they can access to identify items to purchase. In a still further embodiment, the system may be able to scan in pictures or images of the product itself and serve to identify the product in that fashion.

In a still further embodiment, these items may be treated as Hybrid Items as discussed below and user may utilize search functions to search a database of available goods to try and locate what they want. There are also a myriad of other methods which can be used to initially identify the products. The key element of these items is that they can be sufficiently identified that a user receiving what is identified will be satisfied it is what they wanted. At this step (103), the only requirement is that the list (203) be provided to the selected software app without the sub-lists (113), (123), and (133) having been identified.

Further, it should be recognized that while the embodiment of FIG. 1 contemplates that the user open the app first in step (101) and then enter the shopping list in step (103), in an alternative embodiment, these step may occur in the alternative order. In particular, the user may simply choose to scan a product code using, for example, their camera application. The act of scanning the product code (103) may serve to trigger the smartphone to open the purchasing app (101) recognizing that purchasing such a good is the goal of the action. This recognition may be through execution of software in the app, elsewhere on the smartphone, or though the specific type or product code scanned.

The list (203) will typically not be sorted in any fashion and generally will not provide any indication of retailer providing any particular good. However, in certain cases, specific goods may be uniquely associated with a particular retailer. For example, house brand goods are often only obtainable from a single place. However, house brand goods are also often considered interchangeable by a user for the same underlying product in a different house brand. Once the list (203) is entered into the system via the app or related structure (130), the system in block (105) will load databases of files related to the goods and search the databases (107) for the goods on the list.

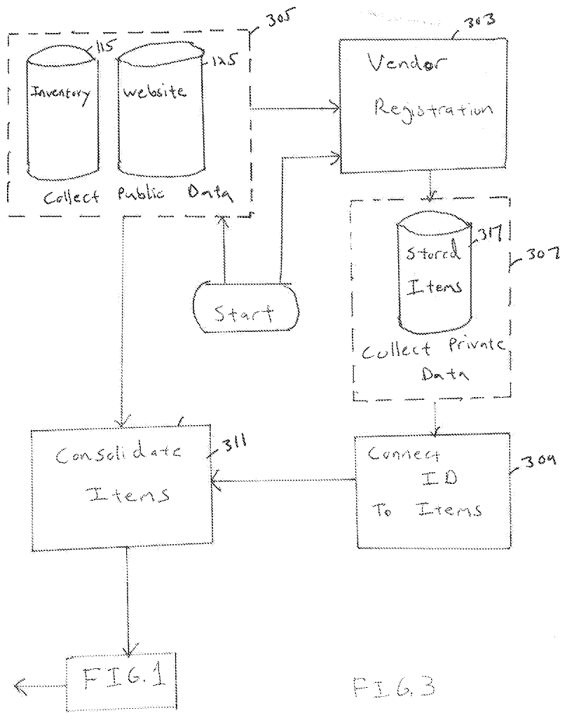

FIG. 3 provides an embodiment of how the available goods in the database may be obtained. Vendors will typically be entered into the system by a couple of different methods based on the nature of the vendor and their existing online presence. In a first embodiment, known vendors such as existing e-commerce retailers with existing e-commerce storefronts may be entered automatically from public data (305). This may be done with or without these vendors even being aware that they have been entered into the system and without their full consent and registration In this case, the vendor need not register specifically with the system (303) as the system may locate them on the Internet or other network and add their items, and a recognition of who they are, to the system acting effectively as a layer above their existing e-commerce site. Registration (303) may still be available or offered to provide advanced features or improved control or monitoring of public vendors as contemplated later.

When a vendor has an existing e-commerce site, the system may obtain information about the inventory of the site via inventory information (115) which may be supplied to the site specifically and provide for improved data, or directly via the existing e-commerce site (125). As a simple explanation of the later, if a site has a product currently for sale, the system may note that the vendor has that product and connect the product to the vendor in its records (105). When the product is indicated to be purchased by a user of the system, the system will effectively simply place the order with the underlying site using information stored about the user to access the underlying site and place for and pay for the order. In this way, the present system acts simply as a front end of the existing e-commerce site.

The databases (115) and (125) will generally comprise an entry or entries for each good which can be purchased from any vendor generally already made available to the public. Thus, the source of the information loaded in (305) is often public information from existing e-commerce sites such as databases (115) and/or (125). Alternatively, this information need not be public but the system may have access to non-public information which resides behind a public facing site (e.g. if they have special access to the inventory information underlying the e-commerce site). Thus, these databases may be associated with an e-commerce vendor that the systems has obtained information from even if obtained without their permission such as through a web crawler or similar mechanism. It should be noted that a vendor whose information is obtained from public sources (305) need not be the actual vendor. For example, sites which allow for public sale by their internal users (for example, Etsy or eBay) can still be cataloged as the goods sold by those sites as the sale by the underlying users can still be purchased through the parent site. Thus, the parent site can be considered a single vendor for purposes of this system.

As indicated in FIG. 3 information may also be drawn from non-public sites and private data (307) may be used. The source of private data will typically be drawn from internal sources such as internal inventory data (317). Many stores utilize electronic inventory control systems and the data may be collected and collated by the system to determine which online stores would have the various items in stock as contemplated in conjunction with inventory databases (115). However, even if traditional electronic inventory control systems are not used, inventory information may be obtained via access to a store's internal data (317) or through access through a supplier, for example. In order to access private data the vendor will typically need to have a relationship with the system which is accomplished by having the vendor register (303) with the system.

Registration may also be provided as an option to vendors even if they can be collected and used automatically by the system as contemplated above without registration. A registered vendor will be specifically known to the present system and will typically be required to provide information to allow them to be identified as a legitimate vendor and sufficient that the present system can carry out a transaction on their behalf. For example, a registered vendor will typically need to provide local tax information so that taxes can be collected on their sales, contact information, and customer service information. In effect, registration works to attach a vendor to the system if the vendor has no way to carry out a transaction without using the system, or to allow a vendor that may still utilize an external e-commerce system to be more directly connected with the system. This can provide enhanced security and trust, for example.

The registration of a vendor with the system will typically allow for the system to verify the vendor and communicate with the vendor securely. It can also provide a specific e-commerce portal via the system and allow for a vendor to upload inventory information to the system. This inventory information, because it will typically be stored by the system, may be in different formats to the format of inventory (115) which is often of a more universal form.

Both the sources (305) and (307) will typically include multiple pieces of information so as to categorize goods. This will usually include an identifier of the good (which may be machine useable identification information or designed for human identification), indications of where the good is located (a warehouse or geographical location, for example), and an identifier of the retailer that has the good for sale. Specifics of the product offering also will typically include a sales price, a method of obtaining the good (e.g. shipping specifics or location for pickup), and other things specific to understand the good being purchased and the costs associated with it. With regards to source (305) this information is typically public and useable via an existing e-commerce site. For example, one can already order products electronically from Amazon.com and related sites by placing an electronic order is via a public portal. Thus, with regards to source (305) the system, in many respects, need only convert a good desired by the user into something which can be identified to that portal to automate the ordering of that good. With regards to the source (307), this is more complicated as the goods (317) are typically not as readily identified or associated and, even if they are, there is not an existing portal through which they may be obtained.

As contemplated above, ordering of goods will typically require the good to be machine identifiable. In an embodiment of the system, to carry this out goods will be identified by a machine understandable identifier to the extent possible. This may travel with the good and be universal for interchangeable goods (for example a UPC code on a box of cereal) or may be more specific to a singular items or both. As an example of the latter, a particular secondhand good may have both an initial identifier in the form of an initial UPC from when it was sold and an identifier for where that particular copy is currently located and identified. In the event that a particular good does not have an identifier, the vendor may be offered the opportunity to set one up or may be automatically provided with one (309). The latter is believed a particularly useful option for small vendors who may not have good access to traditional or online retail and are reliant either on their own private e-commerce platform, or have no electronic sales at all.

In an embodiment, vendors are able to generate specific identifiers for materials they sell on the site. In an embodiment, this is in the form of a machine readable code such as a UPC code. The machine readable form may be of any form including one which would be proprietary to the present system. This can allow for a registered vendor that may not otherwise have the capability to supply material to a larger distributor, to allow a user to enter products with the code because that code is associated with that good. For example, a small retailer that makes candles, but does not normally sell through other retailers, may add a machine readable code specific to this system to their products. This allows a user of this system to scan an existing candle to add that same candle (e.g. scent and size) to their shopping list (203), even if that code is unusable for any other purpose. Alternatively, a vendor who sells completely unique products where each one is different (for example, original paintings) the vendor may utilize each code only once. However, even with only a single use, a user may scan a code on a unique item to obtain items that are similar to the scanned item.

Regardless of if items are from source (305) or (307), the items will typically be consolidated by the system into a single consolidated reference (311) which may be used as a singular source for goods available to all users of the system. In effect, the source (311) comprises a listing of any good that the system can obtain from any vendor it has connected to. This can include mass market goods from mass market retailers that are obtained using their existing e-commerce sites or specific individual and unique items which are not available electronically except via this system. Regardless of the nature of the underlying vendor, the consolidated list (311) may be loaded or made available (105) to the system for use in locating the goods on the list (203)

Once the database is loaded, the list (203) is compared to the consolidated source (311) to locate the items in the search (107). It should be recognized that some items on the list (203) may be in stock and available from multiple vendors which may be in multiple geographical locations, have different delivery terms, and other distinct elements of the goods' purchase. Even if sold by a single vendor, items in inventory may still be in different physical locations (e.g. store branches or warehouses). Still further, user specific preferences or further refinement of desired goods may be necessary for goods to be identified. In the event that an item is available from multiple places (which will generally be quite common for certain types of goods), there will typically be a requirement for the system to determine an initial preferred supplier and location. All of these items are necessary to develop initial sub-lists for purchases in step (109).

Because of the need to refine the initial goods to made sure it has the correct products to be purchased, the system will typically first obtain a collection of initial results (106) of possible goods which may be refined by the user (108). In the step (106), the specific goods the user wants will typically be at least partially unknown or the machine may be unsure if the good is specific or needs refinement. This is different from step (111) where the good is definitively known, but the source is not yet known.

With regards to locating a specific good in step (106), in many cases a good can be readily identified. For example, a 20 oz box of Cheerios brand cereal is a specific known item which can be readily identified and requires no further refinement. These types of mass market interchangeable goods are readily identified and distinguished from other similar goods. Specifically, a machine search for such an item will typically have one accurate result. Further, one of ordinary skill in the art will be aware of systems which can be used to obtain lists of these types of goods from a user input list of goods. In the present case, the items in Item Groups I (113), II (123), and III (133) are considered these kinds of goods and, therefore, they will simply pass through steps (106) and (108) to be added to list (109).

As opposed to these fairly interchangeable goods of a type which are regularly purchased and easily identifiable, one power of an embodiment of the system is to be able to order disparate goods at the same time. This embodiment includes goods which are widely different from each other and which many require specific or unique vendors. In FIG. 1, these are the Item Groups IV (143) and V (153).

Group IV (143) includes an item that is called in this disclosure a “Selection Required Item”. A Selection Required Item is an item that the user would be unlikely to wish to purchase without having seen specifics of the exact item they will be purchasing and where they generally have little to know idea what they actually want to purchase beyond a basic concept. In many respects, this is the typical item that one would go “shopping” for and would have difficulty obtaining if there are no options presented. Examples of such an item are often unique (although need not be) or are of something not purchased previously. A good illustrative example is a product purchased as a gift for someone else. In this case, the user has a general understanding of what the person might like, and, from that, a general understanding of what they may be interested in purchasing. The user will also often have a budget and similar limitations in mind. What they need is to find a good that meets all these criteria which would cover a wide array of things, but once goods that meet them are located, other criteria may become apparent.

While a gift is an excellent example of this type of item, another is a unique good where many similar goods occupy a similar description, but all are typically different in ways which are very important to an end consumer. A good example of this is the purchase of an original artwork. Such a good is often unique in hard to quantify ways. Further, even if not truly unique (for example if prints are made of an artwork), the individual items may still be unique (e.g. they may be numbered or have other criteria making each unique) and are often still difficult to expressly describe unless one is a regular consumer of such items. The artwork example will be used in this discussion purely for illustrative purpose and in this particular example, the Item in Group IV (143) is a picture of a horse that the user wishes to obtain to fill a space in their home. This example uses a piece of art for simplicity and because it is particularly useful to illustrate recognizing that purchasing art and grocery items in the same transaction is likely uncommon.

Purchasing a piece of art will often require viewing multiple items with a user not really knowing what exactly they want until they see it even though the general category and description of the desired good is quite simple and searchable. This is really the defining element of a Selection Required Item here. A Selection Required Item is the type of thing that a traditional retail shopper would often go to multiple locations and view many options to obtain. As would be understood, a Selection Required Item may be many different things and while art is illustrative it is by no means comprehensive. Further, what constitutes a Selection Required Item may be different for different users. The key element of a Selection Required Item for purposes of this disclosure is that the item will typically be something that the user has not yet located, so it cannot be identified with specificity (e.g. the user cannot identify a particular painting by a particular artist that they wish to purchase). Most importantly, the user can typically not provide a machine readable code to identify the item because they don't have it yet and the code is likely unique to the specific item. Instead, the user can only provide a general description of the item and will need to compare multiple items to decide if it is what they are looking for. In this way, the user will need to be provided with options to attempt to resolve what item they are looking for.

Item Group V (153) includes what is referred to herein as a “Hybrid Item”. A Hybrid Item, like a Selection Required Item, will typically be something that the user wishes to see prior to purchase and obtain specifics about the exact item they will be purchasing before completing a transaction. However, as opposed to ta Selection Required Item where the user will typically not know exactly what they want (or at least cannot identify it with sufficient specificity that a machine can provide a single item in response to a query for it), in a Hybrid Item the user may know specifically what they want, and can actually describe it, however, they will want to verify that the item they are sold will actually meet their requirements.

A good example of a Hybrid Item is purchasing a secondhand (used) item or purchasing an item where something about the item is important to this specific user that may not by other users. In the present disclosure, the Hybrid Item is considered to be a used collectible lunch box (although again, it is recognized that such an item would not typically be on the same list as grocery items). In this case, the item can be provided with specificity, and a machine readable code may even be available as the item was a mass market item at some time in the past. However, as used collectables can come in a variety of grades, states, and price points, the user will often want to view the specific item to make sure they are willing to purchase it because of these other criteria, even if it meets all the mass market criteria they have specified for the item they are looking for.

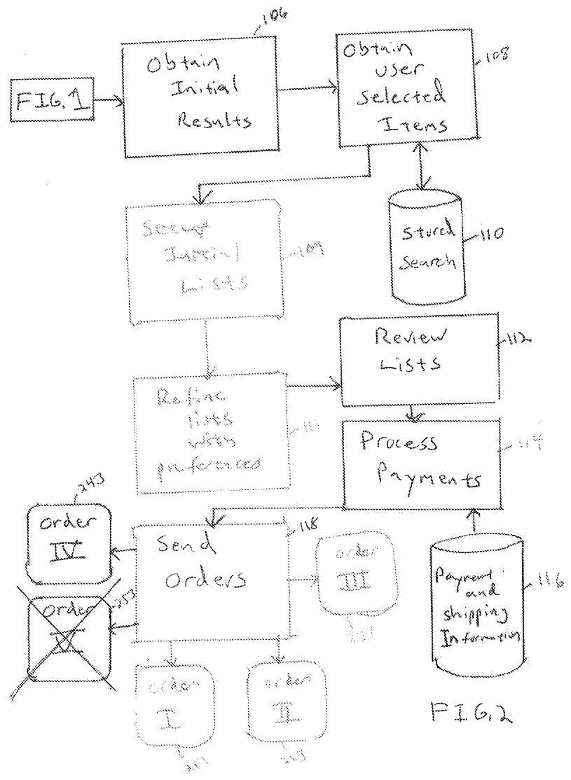

In the depiction of FIG. 1, these items are also placed on the list with the items (203) however, they may also be provided totally separately. In an embodiment, the system may determine that an items is a Hybrid Item or Selection Required Item based on how it is entered (e.g. scanning a machine readable code versus typing a language description) or based on the type of item it is. For example, if a machine readable code is entered which matches multiple items from different vendors, the item will typically not be a Selection Required Item. If it matches a code which is not in current inventory systems (e.g. not in database (115)) it will typically not be a mass market item and is more likely a Hybrid Item. Regardless, in FIG. 2, items which are not readily connected to single search results will require user input in step (108) to select.

With regards to a Selection Required Item, the user will generally indicate to the system which item they want and the system will need to provide a selection of items meeting general criteria, but where no one result is clearly the sought item. In many respects, this is the type of shopping experience offered when using a general search engine to search for a good. Thus, the system will typically give the user the ability to enter a wide variety of criteria about the item. This may be textual (for example, they may indicate that they want an oil painting of a horse), may be image based (they may upload a picture of other art they have of a similar style they want to match, or a sofa that they want the art not to clash with), or may be of any other form. Once all the information has been entered, the system will parse the search and seek out items (107) which it believes meet the criteria. The parsing of the search may occur in any fashion and using any search technology. In an embodiment of neural network or other artificial intelligence (AI) engine may be used.

Once the search is parsed, the system in an embodiment, will return what it believes to be a best result. Items to be returned will need to be available on the system from a vendor as contemplated above. In many cases, because of the unique nature of many of these items they may be from specific registered vendors and registered vendors may, in an embodiment, be a preferred, or even the only, type of vendor able to respond to these requests. Typically, the item selected by the system will be presented in a digital display to the user to review the item and determine if it is what they are seeking. This will typically involve photos and may involve text or other descriptions. Multiple items may be presented at once for comparison in an embodiment. If the item is something that a user is interested in, they may select to buy it at that stage. Alternatively, if it is not, they may “bookmark” it to allow them to find it later (for example, if they like it but want to compare other items), may indicate that they like it, but it is not what they want, or may simply indicate that it is not what they want. This selection may occur via any method and in an embodiment may occur using the well-known “swipe right or swipe left” arrangement where the user may approve or disapprove of an item. When an item is not purchased, but is removed from the display, the system will typically display another item based on the search criteria provided so far and may be based on the user's indicated interest in other prior items that have been presented.

It should be recognized that when the system switches to a new item, that item may be from a totally different vendor than the present item. In order to provide a more universal experience, registered vendors may be required to provide information on the items in a standard form arrangement so that the displays appear fairly uniform to the user as they traverse the displays. Further, it should be understood that a user's response to a particular item provided from a search will typically be used to refine the search and to provide for new items that are expected to meet the refined criteria. A user may also refine criteria when they select or reject items in a certain fashion. For example, they may indicate in response to a particular item presented that they like the composition, but want something bigger. This can also be taken into account.

Once a user has located the desired item using the system, purchasing will typically occur in the same fashion as discussed below in conjunction with Item Groups I (113), II (123), and III (133) as the item has now been specifically identified. In an embodiment, if multiple Selection Required Items (or Hybrid Items below) are part of the same order list, the system may resolve those other items before finalizing any transactions. Specifically, because these items will typically only be available from a very few or a single vendor, purchase of other items from those vendors (if available) may be of highest value. In an embodiment, when such multiple items exist on a single list, the system may preference items from a vendor where one or more other items have been chosen both to select similar items that may be more likely to be desirable, and also to combine shipping or other benefits as contemplated above.

A Hybrid Item will typically operate in the same fashion as a Selection Required Item. However, a Hybrid Item will often utilize a more simplified search up front. Specifically, if the user is looking for an old item (such as an out of stock item) or a used item, they may be able to specifically identify it. As indicated above, the present example of a Hybrid Item is a collectable lunch box. In this case, the lunch box likely had a UPC code or other identifier when it was originally sold. If the user has this information they may scan it or otherwise enter it. The system may identify items specifically by the machine readable code (for example if the system had access to dead inventory which may meet the criteria), or may treat the item as a Selection Required Item generating its own search from criteria it obtains from the machine readable code.

Once located, the Hybrid Item may be presented to the user in the same or a similar form as a Selection Required Item. However in this case, additional information about the specific item (e.g. a condition or specific such as if it is supplied with original packaging) may be provided. Again, a user may indicate that the item is the one they wish to purchase, that it is of interest (e.g. bookmark it) or that it is not what they are looking for.

In both the Hybrid Item and Selection Required Item cases, the user may be provided with the opportunity to interact directly with a vendor of the item. This can allow them to ask questions or to even indicate to them their needs with the item. For example, if a user sees a painting they particularly like but would like a larger one, instead of treating this as any other “bookmarked” item, they may contact the vendor and indicate that they like it and what they particularly like, but that they would like a larger format. The vendor in this case may then act to supplement the automated search engine and provide which of their items may fit the user's needs. In an embodiment, the vendor may also offer custom items that can be made directly in response to the user's needs. For example, in the case of an artwork, the artist may do works on commission where the user can find them through the site because they produce the type of art they are interested in purchasing, and then negotiate with the vendor directly through the system to contract to purchase a specially commissioned piece from them.

Further, because of the nature of a Hybrid Item and a Selection Required Item, a user may not find anything that is currently available that meets their needs or may tire of searching having gone through a certain number of goods. In this case, the user may maintain the item on a list for future use without purchasing it. Thus the search may be stored (110). In such situation, the system may notify the user when a new items is added that they think may be of interest to the user based on the stored search (110). Alternatively or additionally, the system may provide more items based on the search (110) every time the user shops on the system for other items, or as requested by the user.

As should be apparent from the above, the present system provides for a much more centralized shopping experience which is more akin to a physical shopping experience at a shopping center, mall, or other collection of retailers that are physically housed together. A user with a list of things to purchase which includes both standard goods as well as items that they will need to specifically seek out, can go to a single electronic location in the form of the software of the present system, obtain specific items by looking them up directly, and then “browse” for other items that they may not know specifically by utilizing the selection required and hybrid search functions. Basically, selection of items by a user (108) can involve automation of easily located items in conjunction with search functionality for more open items. This combines different functions of internet portals in the same general space. Once all the items have been selected, the user can then consolidate their items across multiple vendors to simplify fulfillment, and utilize a single point checkout to have them purchased with a modicum of work. Thus, the electronic retail environment now better mimics the physical shopping experience where both items to be shopped for and items specifically to be bought are sought.

Once the items to be bought have been selected (108), the system will setup an initial list of items (109). At this stage, the items in all the Item Groups I (113), II (123), III (133), IV (143), and V (153) have either been selected or the searches have been saved. For purposes of this example, this disclosure is going to present the case that the user has located a desired artwork meeting the criteria of Group IV (143), but has not located the lunchbox of Group V (153) and has stored (110) that search.

Various preferences in the system may be used to determine where to obtain the various products from in steps (109) and (111). These preferences may be of any form and may be absolute preferences or may be in the form of conditional preferences. In an embodiment, this preference selection may be a combination of two forms. The first of these forms is initial preferences of the system itself which are functional and attempt to group the items on the list (203) into a manageable number of sub-lists in step (109). In this first component, the goal is to create sub-lists of goods which are obtainable by this user, even if not preferred. As a simple example, this component in step (109) would not create a list which involved purchasing the fresh grocery items of the first list (113) from the specialty store even though the specialty store is indicated as having them available according to the databases (115) and (125). As indicated above, these items are not available to this user from the specialty store because the user is not local to the specialty store as indicated above.

In an embodiment of list generation, the system will build the sub-lists to have only necessary suppliers and a minimum number of suppliers. That is, at step (109) items are grouped to be shipped or picked up together whenever possible and a vendor is not selected if the goods of that vendor can be supplied by a different vendor in combination with other goods also on the list. Thus, in this example, the fresh grocery items of list (113) are selected for pickup at the local branch of the large retailer along with the items of list (123) as this results in all items being obtained from two vendors (the minimum). It should be recognized that the artwork of Group IV (143) is sufficiently unique and different from the other items in the sub-lists that it will likely require a specific vendor who is unable to supply any other items. Thus, selection of its vendor is simple in step (109) as there is basically only a single option available. To the extent there is conflict or multiple possibilities of different vendors, the system may select a lower price or other criteria to decide which sub-list an item is on. Thus, the system would not place the limited items from sub-list (123) on a list to be ordered from the specialty vendor (unless some other criteria made it necessary, such as a shipping minimum), as they can be ordered at less cost from the branch of the large retailer, which has to be ordered from anyway to get the other packaged goods of list (123), and which can supply the fresh grocery items of list (113).

Price and other related differentiators between goods are a typical first form of preference regardless of stated user preference and making these types of determinations allows for a more manageable group of vendors to be reviewed by the user (112) and to which their individual preferences may be applied in step (111). In this particular example, the three different sub-lists I (113), II (123), and III (133) of the list (203) contemplated above are separated into just two sub-lists and each is associated with the specific vendor (large retailer and specialty store) as contemplated above. The green grocer is not currently indicated as a vendor that will be used in step (109).

In this way, the total number of vendors and groupings will be reduced. However, this arrangement may not be desirable for the user as the user may have preferences other than the defaults above. In step (111) these preferences are applied. For purposes of example, the user here has a preference to not have to pickup items. In step (111) application of this preference means that the packaged goods of the list (123) are not being provided in the preferred fashion and neither are the fresh grocery items of list (113). While in some cases, this preference may not be obtainable or may conflict with another preference, in this example, both lists of items (113) and (123) can be delivered if the green grocer is used to supply items (113) (as the green grocer will deliver locally) and the items (123) can be shipped so long as they are not purchased at the same time as items on list (113). Thus, in this case, the system will adjust the lists in step (111) so that fresh grocery items (113) will be delivered by the green grocer and the packaged goods (123) will be shipped by the large retailer from the warehouse.

It should be recognized that the second set of preferences above indicated in step (111) is merely exemplary and any type of user preference may be used. These preferences may be as complicated or as simple as desired by the user and the preferences may be indicated by the user with hierarchical selection or by other methods to resolve conflicts between preferences (or not). Based on the step (111) and as should be apparent from the above, placing an item on a list in step (109) or modified in step (111) need not be a static or absolute process. Instead, items ordered at different times may be provided in different ways. For example, should the green grocer not happen to have certain items from list (113) in stock this week, the items from list (113) may be placed on a list for pickup at the large retailer even if that is against the default preference. Alternatively, the system may indicate that the items are not available in the preferred manner and only generate sub-lists for those items that are available in the preferred fashion. Again, it should be recognized that preferences of steps (109) and (111) can be virtually anything and in different embodiments selections may be based on a user having a preferred vendor to obtain items from which will be used if that vendor has the item, to receive the items in fewer packages, with faster shipping, with lower cost shipping, with more or fewer pickups, from national or local retailers, according to certain brand preferences (or lack thereof), any other type of preference, or any combination of preferences.

Once the sub-lists have been created in (109) and refined in (111) they are also associated with the intended vendor. Even if the second set of preferences has been automatically used in the sorting, the user will still generally be asked to review the various orders and make sure they agree with how the items are to be provided in a review step (112). As part of this review (112), the system may indicate to the user if there are alternative locations that any item may be obtained from or if there could be a benefit from using an alternative vendor (e.g. if an item is moved between vendors, the user may obtain discounted shipping, or faster availability) even if this would go against a stated preference of step (109) and/or (111). For example, the system here may provide the initial of pickup of sub-lists (113) and (123) from the local branch of the large retailer instead of having list (113) delivered by the green grocer and items (123) be shipped even though this option is against the specific user preference. In an alternative, embodiment, user approval step (112) may be skipped and the system may proceed straight to the step of ordering.

Once the sub-lists have been reviewed and approved (112), the payment for the lists will be processed (114). Payment will typically use stored payment and shipping information (116) of the user. Depending on embodiment, payment may be made for all of the list (203) in a single lump sum to the system and the system may then pay vendors individually using its own payment mechanisms. Alternatively, payment information may be provided by the system to each vendor specific to the user. For example, in a case of mass market items obtained from a retailer having an established e-commerce portal. In this case, list II (123) is such a list. In this case, the system actually uses stored login criteria of the user (116) to log into the user's account on the large retailer's e-commerce site and the goods on list II (123) are entered as that user placing an order on that site as part of step (118). Payment and shipping information is also similarly provided from memory (116). The list II (123) thus becomes order (223).

Combinations and variations on the above will typically be made based on the specifics of the vendors selected in step (112) and sending the orders (118) will result in four orders (213), (223), (233), and (243) being placed with the vendors indicated. In this case, list I (113) becomes order I (213) and is ordered from the green grocer for delivery, list II (123) becomes order II (223) and is placed with the large retailer for shipping (as discussed above), list III (133) becomes order III (233) and is placed with the specialty store for shipping and list IV (143) is processed by the system with the system placing order IV (243) with the artist directly. Order V (253) is shown crossed out as no order was made from List V (153) as the desired good was not located in this shopping trip. The orders I (213), II (223), and III (233) will typically be submitted via the standard online ordering processes of the three vendors or may bypass the front end of such a system and submit electronically and directly. Order IV (243) is contemplated as utilizing other methods as the vendor of the artwork of Item IV (143) is considered to not have an e-commerce portal in this embodiment. In this case, the order IV (243) is rendered as a paper order including the payment and shipping information (116) and sent by the system to the vendor.

As part of placing orders (213), (223) and (233), the system will typically load supplied purchasing information (for example stored account information for a selected retailer, credit card numbers, bank information, or electronic payment systems such as, but not limited to systems such as ApplePay or Venmo) (116) and use this information (116) to supply appropriate payment to each of the vendors for each order (213), (223) and (233) but the vendor may utilize internal or alternative payment mechanisms (for example B2B EFT systems) in an alternative embodiment and then the system may pass through the cost using the payment information (116). This completes the orders (213), (223), and (233) and the order should be supplied by the vendor in the selected fashion in accordance with normal fulfillment processes of that vendor as selected back in step (112).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “rectangular” are purely geometric constructs and no real-world component is a true “rectangular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric or other meaning of the term in view of these and other considerations.

1. A method for consolidated electronic ordering, the method comprising:
providing a software portal for accepting a consolidated list of items from a user;
breaking the consolidated list of items into a plurality of sub-lists, all items on each sub-list in the priority of sub-lists are available from a single vendor;
determining preferences of the user with regards to ordering;
modifying the plurality of sub-lists into a plurality of modified sub-lists wherein:
the plurality of modified sub-lists are different from the plurality of sub-lists; and
all items on each modified sub-list are available from a single vendor;
retrieving stored ordering information of the user; and
automatically providing at least a portion of the stored ordering information to a vendor for each modified sub-list so that the vendor is given an order for the items on each modified sub-list and will supply the items on the modified sub-list to the user.

2. The method of claim 1, wherein the software portal is a software application for use on a mobile device.

3. The method of claim 1, wherein a plurality of the items are available from multiple vendors.

4. The method of claim 1, wherein the stored ordering information includes payment information.

5. The method of claim 1, wherein the stored ordering information includes shipping information.

6. The method of claim 1, wherein the stored ordering information includes delivery information.

7. The method of claim 1, wherein the items include a mass market item available from multiple vendors.

8. The method of claim 1, wherein the items includes a unique item only available from a single vendor.

9. The method of claim 1, further comprising: showing the user an item based on an indicated item on the list that may or may not be the item on the list and the user will indicate if they wish the shown item to be placed on a sub-list as the indicated item or not.

10. The method of claim 9, further comprising: showing the user another item that may or may not be the indicated item on the list when the user indicates not to place the shown item on the sub-list and the user will indicate if they wish the another shown item to be placed on a sub-list or not.

11. The method of claim 1 wherein the order is supplied using an existing e-commerce portal of the vendor.

12. The method of claim 1 wherein the order is supplied in a non-electronic form.
